(19) United States
(12) Patent Application Publication
(10) Pub. No.: US 2010/0294791 A1
(43) Pub. Date: Nov. 25, 2010

(54) Tablet Dispenser

(75) Inventors: Ludwig D. Weibel, Waldstatt (CH); Fritz Dill, Langenthal (CH)

Correspondence Address: RANKIN, HILL & CLARK LLP, 23755 Lorain Road - Suite 200, North Olmsted, OH, 44070-2224, US

(73) Assignee: VIFOR (INTERNATIONAL) AG, St. Gallen (CH)

(21) Appl. No.: 12/745,705

(22) PCT Filed: Nov. 7, 2008
(86) PCT No.: PCT/EP08/65097

§ 371 Date: Aug. 16, 2010

(30) Foreign Application Priority Data
Dec. 7, 2007 (EP) 07122586.6

(51) Int. Cl. B65D 83/04; B65G 59/02

(52) U.S. Cl. 221/1; 221/154

(57) ABSTRACT

What is proposed is a dispensing device for dispensing tablets belonging to a stack of tablets separately. There is arranged, in a casing (100), a conveying element (200) which can be moved to and fro, in relation to said casing, between a dispensing position and a conveying position. The dispensing device also comprises holding means, in particular a lift element (300), which cause the stack of tablets to be kept stationary when a movement of the conveying element, relative to the casing, from the dispensing position into the conveying position occurs, and which cause said stack of tablets to be entrained towards the removing aperture by the conveying element when said conveying element returns to the dispensing position. In this way, the stack of tablets is conveyed in the direction of conveyance by a predetermined amount, particularly by the thickness of a single tablet, when a forward-and-backward movement of the conveying element occurs, and said single tablet can be easily removed.

### TECHNICAL FIELD

The present invention relates to a dispensing device for tablets which are essentially flat. In addition, the invention relates to a method of removing a tablet from a dispensing device for tablets. The device is suitable for receiving a stack of tablets and for dispensing the tablets separately, that is to say singly or in a predetermined number. The tablets in question may be, for example medicinal preparations in tablet form, other health-promoting preparations, for example vitamin tablets or food supplements, sweets or chewing gum in tablet form, detergent tablets such as washing-machine or dishwasher tablets, etc. Although the invention is not limited to a specific type of tablets, it is nevertheless quite especially suitable for tablets which have to be protected from moisture and/or mechanical damage. Tablets which need to be reliably protected against mechanical damage are, above all, medicaments which are available in tablet form and which need to be consumed by patients in doses for therapeutic purposes. Vitamin preparations which are administered in the form of tablets, or medicaments which contain iron or iron compounds, must be properly protected against moisture. Dispensing devices of this kind will also be referred to below as tablet-dispensers or tablet-distributors for short.

### PRIOR ART

From the prior art, various possible ways of dispensing tablets to a user singly from a stack of tablets are known.

Dispenser inserts or caps for small standard tubes of tablets are known from WO 03/086901 or WO 2005/112672. Whereas an insert or cap of this kind does indeed make possible easy separation of the tablets, the small tube has to be placed on its head so that the tablets pass into the dispenser insert as a result of gravity. This is unsatisfactory.

This disadvantage can be avoided by providing, in a tubular casing, a spring-loaded lift element which presses the stack of tablets towards the upper, open end of the casing. There is then provided, at the upper end, a removing mechanism which makes it possible to remove one single tablet at a time. Examples of solutions of this kind are indicated in U.S. Pat. No. 5,071,033, U.S. Pat. No. 5,366,112 or US 2003/0132239. What is disadvantageous about such dispensers, however, is the fact that a spring which covers a very large range of resilience (essentially the entire height of the stack of tablets) is needed. The consequence of this is that tablets must be initially exposed to a very high spring force and are then subjected to very high mechanical loads. Damage to the tablets may result, that is to say particularly if, after a tablet has been removed, the tablets located underneath it are finally forced towards the upper, open end with relatively great force and speed. A high spring pressure can also lead to an uppermost tablet being removable only with difficulty.

In U.S. Pat. No. 6,230,931, a dispenser is disclosed in which a stack of tablets rests on a lift element which is accommodated in a tubular casing. The lift element can be displaced, in relation to the casing, towards a removing aperture via a ratchet connection. In this instance, the ratchet connection prevents the lift element from being pushed back, counter to the direction of advance. An actuating button for the lift element passes towards the outside through a longitudinal slit in the casing and enables a user to push the lift element, and with it the stack of tablets, forwards in the casing. What is particularly disadvantageous about this design is that the casing necessarily has a slit, as a result of which it can no longer be sealed in an air-tight and moisture-tight manner. Since the tablets are openly accessible, they can easily become contaminated. The dispenser described is unsuitable for tablets, such as effervescent tablets for example, which are sensitive to moisture.

In U.S. Pat. No. 7,204,391, it is proposed that tablets be accommodated, arranged in a row along their peripheral edges, in a first, inner tube which is surrounded by an outer tube. The tubes can be twisted, counter to one another, about their common longitudinal axis. Accommodated in the inner tube is a lift element which, on the one hand, is guided in a linear manner in the inner tube along the longitudinal axis of the latter and which, on the other hand, is guided, through a longitudinal slit in the inner tube, in a helix-shaped guide track in the outer tube. If the inner tube is now twisted in relation to the outer tube, the lift element follows the helical track in the outer tube and is thus displaced, relative to the inner tube, towards a removing aperture in said inner tube. The lift element thereby pushes the tablets located in the inner tube forwards. Since the tablets are arranged in a row along their peripheral edges, either it is possible to accommodate only a few tablets, or else the tubes have to be disproportionately long. What is also disadvantageous about this design is the fact that it cannot easily be operated with one hand. In order to be able to twist the inner tube in relation to the outer tube with a sufficiently easy action, there must also be a clearance between the two tubes. Air and moisture can then penetrate into the interior in disadvantageous manner via said clearance. If no clearance is present in such a solution, it becomes very difficult to manipulate the dispensing device, since a correspondingly high expenditure of force has to be applied to operate it. Inadvertent rotations can lead to the tablets not being fixed in position by the lift element. Movements can then easily damage the tablets mechanically.

### DESCRIPTION OF THE INVENTION

It is the object of the present invention to indicate a dispensing device for dispensing tablets which has improved properties, and also to indicate a method for removing a tablet from a dispensing device. It is preferably an object of the present invention to indicate a dispensing device far dispensing tablets separately, which permits the simplest possible operation in any desired orientation, which is constructed so as to be sealable in a moisture-tight manner, and which can be produced cost-effectively.

This object is achieved, in particular, by means of a device having the features in claim 1. Advantageous refinements are indicated in the dependent claims.

What is proposed, therefore, is a dispensing device for receiving a stack of tablets and for dispensing tablets belonging to said stack separately. The dispensing device comprises a casing which receives the stack of tablets. Said device also has a removing aperture which allows the removal of one single tablet, or of a predetermined number of tablets, for example two or three tablets, at a time. This removing aperture is not necessarily delimited solely by the casing, but may also be delimited by other elements belonging to the dispensing device. The casing may also comprise a lid, in particular a folding lid. The dispensing device comprises a conveying element which serves to convey the stack of tablets to the removing aperture along a direction of conveyance. This conveying element can be moved to and fro, in relation to the casing, between a dispensing position (normal position/extended position) and a conveying position (activated/pushed-in position). The dispensing device comprises holding means which are constructed as follows: When a movement of the conveying element from the dispensing position into the conveying position occurs, the holding means hold the stack of tablets, relative to the casing, in such a way that said conveying element is displaced, in relation to the stack of tablets, counter to the direction of conveyance. When, on the other hand, a backward movement of the conveying element from the conveying position into the dispensing position occurs, the holding means hold the stack of tablets in such a way that it is entrained in the direction of conveyance by the conveying element. Overall, therefore, what the conveying element and the holding means bring about, in interaction with the casing, is that the stack of tablets is conveyed in the direction of conveyance by a predetermined amount every time a forward-and-backward movement of the conveying element occurs. This predetermined amount may be, in particular, the thickness of a single tablet or of a predetermined number of tablets.

A dispensing device of this kind makes very simple operation possible. After a tablet has been removed from the removing aperture, it is merely necessary to move the conveying element, in relation to the casing, into the conveying position and back into the dispensing position in order to make a new tablet or a predetermined number of new tablets available in the removing aperture. As a rule, the moving of the conveying element into the conveying position is effected manually by the user. The backward movement is preferably effected by an elastic element which will be described again in greater detail below, but said movement may optionally also be effected manually. This function is independent of the orientation of the dispensing device. The conveying element can readily be arranged completely inside the casing, so that it is possible, without any problems, to construct the dispensing device so as to be sealable in a moisture-tight manner. The entire device can be cost-effectively produced from plastic by the injection-moulding method.

In one form of embodiment, the stack of tablets is hindered from moving, in relation to the casing and/or to the conveying element, in discrete stages counter to the direction of conveyance. Within each stage, the stack of tablets can be moved to and fro in relation to the element in question. However, as soon as the next stage is reached in each case, backward movement of the stack of tablets in relation to the casing or to the conveying element is no longer possible beyond this stage. Under these circumstances, the distance between stages may correspond to the thickness of a single tablet or of a predetermined number of tablets. However, it may also correspond only to a fraction of the typical thickness of a tablet, for example 0.5 to 2 millimetres, so that the device can be filled with tablets of different thickness. In particular, it is possible, by means of the device, to administer tablets having a thickness which corresponds to an integral multiple of the distance between stages.

In order to construct the dispensing device so as to be sealable in a moisture-tight manner, or to be able to seal it in a moisture-tight manner, it is normally sufficient for parts which are connected, or can be connected, to one another to have no clearance when in the connected state. If therefore, for example, an outer tube of the dispensing device which is part of the casing is sealed at one end (the upper end) with a lid, no clearance or gap then remains between the tube and the lid. The lid is preferably connected in a form-locking manner to one end, the “upper” end, of the outer tube in order to thus close the said upper end in a particularly reliable manner. In particular, there is then a press fit between the lid and the outer tube, in order to thus guarantee a moisture-tight seal in a particularly secure manner. The other, “lower” end of the outer tube is also sealed in a moisture-tight manner by means of a base. There is then no passage, gap or the like via which moisture could pass into the interior of the dispensing device.

The base of the casing may be a separate part which seals the other (lower) end of the outer tube without any clearance. In order to provide a moisture-tight connection between the lower end of the outer tube and the base in a particularly reliable manner, there is a press fit between the base and the outer tube. An integral connection between the base and the lower end of the outer tube guarantees, in a still more reliable manner, that no moisture, for example in the form of moist air, can penetrate into the dispensing device.

In a preferred form of embodiment, the holding means comprise a lift element on which the stack of tablets rests with its proximal end (that is to say, with the “lower” end, which is the opposite end from the aperture). The lift element then interacts with the casing in such a way that it can be moved, in relation to the casing, along the direction of conveyance, for example in discrete stages as has been described above, whereas it is hindered, at least in stages, from moving counter to the direction of conveyance. The lift element also interacts with the conveying element in such a way that it permits a movement of the conveying element, in relation to the casing, counter to the direction of conveyance, whereas it is entrained by the conveying element when a movement of the latter in the direction of conveyance occurs. In other words, the lift element can also only be moved, in relation to the conveying element, in the direction of conveyance, for example likewise in stages, whereas it is hindered, at least in stages, from moving, in relation to the conveying element, counter to the direction of conveyance. What can be achieved in this way is that the stack of tablets is conveyed in the direction of conveyance by the predetermined amount in each case when the forward-and-backward movement of the conveying element occurs.

This functioning can be achieved through the fact that the lift element interacts with the casing via a ratchet connection which permits a movement of the lift element, in relation to the casing, in the direction of conveyance and prevents a movement, in stages, counter to said direction of conveyance. For this purpose, there may be constructed, on an inner face of the casing, a plurality of blocking elements, for example in the form of blocking scales (retaining teeth) or blocking cams, which are arranged one behind the other along the direction of conveyance and which interact with at least one first latching region of the lift element in such a way that they permit a movement of the lift element, in relation to the casing, in the direction of conveyance and prevent a movement, at least in stages, counter to said direction of conveyance. In order to press the latching region of the lift element elastically against the blocking elements, the lift element may be elastically deformable, transversely to the direction of conveyance, against a deforming force, and the latching region of the lift element is then pressed against the blocking elements by said deforming force. For this purpose, the lift element may have one or more slits which extend essentially along the direction of conveyance. Alternatively, however, it is also possible to configure the first latching region as an elastic spring tongue, so that the lift element does not have to be deformable as a whole. In order to better distribute the retaining forces, it is also possible to provide, on the lift element, a number of first latching regions which are arranged one behind the other along the direction of conveyance.

Under these circumstances, the distance between the blocking elements determines the size of the stages by which a movement of the lift element in relation to the casing is prevented, in stages, counter to the direction of conveyance. As has already been described above, this distance may correspond to the thickness of a single tablet or of a plurality of tablets, or else it may correspond only to a fraction of the thickness of a typical tablet. In this case, the interaction of the latching region of the lift element with the blocking elements may be configured in a manner similar to that of a cable-binder.

The first latching region of the lift element may pass through one or more slits in the conveying element which extend essentially along the direction of conveyance. The first latching region of the lift element then extends through the slit or slits in order to interact with the blocking scales on the casing. In this way, the conveying element can be fixed in position, in relation to the casing and to the lift element, in a direction transverse to the direction of conveyance.

This configuration of the lift element is particularly advantageous if the conveying element is of essentially tubular construction. In this case, the conveying element preferably has two slits which are arranged in a diametrically opposed manner. In this case, the lift element is accordingly preferably guided in the conveying element along the direction of conveyance, and has two or more latching regions in the form of latching cams which are diametrically opposed in pairs and which extend radially through the two slits. In this case, the lift element is preferably of plug-like construction, that is to say has a covering wall for the stack of tablets to rest on and a preferably cylindrical or frustoconical side-wall region out of which latching cams protrude radially. The lift element preferably tapers slightly towards the aperture, in order to thus guarantee, in a particularly reliable manner, trouble-free movement, relative to the conveying element, in the intended direction.

The lift element preferably interacts with the conveying element via a second ratchet connection which permits a movement of the conveying element, in relation to the lift element, counter to the direction of conveyance and causes said lift element to be entrained by the conveying element when a movement of the latter occurs, in relation to the casing, in the direction of conveyance. In other words, the second ratchet connection causes the lift element to be movable, in relation to the conveying element, in the direction of conveyance, whereas it is hindered, in stages, from moving in the opposite direction. For this purpose, the conveying element once again has, for example, a plurality of blocking elements, for example in the form of blocking scales or blocking cams, which interact with at least one second latching region of the lift element in such a way that they permit a movement of the conveying element, in relation to the lift element, counter to the direction of conveyance, and impede it in said direction of conveyance. It is once again advantageous, under these circumstances, if the lift element is elastically deformable, transversely to the direction of conveyance, against a deforming force, in order to thus press the second latching region elastically against the blocking elements on the conveying element by means of said deforming force. For this purpose, slits may once again be provided in the lift element, or else the slits already mentioned, which permit the deformation for the first latching region, may also serve to permit the deformation for the second latching region. What has been stated above regarding the distance between the blocking elements on the casing applies, in corresponding manner, to the distance between the blocking elements on the conveying element. In this case too, a number of second latching regions which are arranged one behind the other in the direction of conveyance may likewise be provided.

Particularly if the lift element is plug-shaped and is guided in a tubular conveying element, the second latching region may be formed by a proximal edge (that points away from the removing aperture) of the lift element, and the blocking elements may be constructed on the inside of the conveying element.

In an alternative configuration, the lift element may be guided, in relation to the casing, in a control cam which, because of its shape, permits the lift element to be entrained by the conveying element in the direction of conveyance, whereas said control cam prevents a movement of said lift element, in relation to the casing, counter to the direction of conveyance in stages. For this purpose, the control cam may have a jagged shape with first sections which extend at a shallow angle to the direction of conveyance, and with second sections which extend essentially transversely to said direction of conveyance. The lift element is provided with a control pin which is guided in the control cam. When the control pin is located in the first sections, the lift element can be displaced in the direction of conveyance and passes, by means of the pin, into the region of the second sections. As soon as said control pin is located in the second section, it can no longer be moved back, counter to the direction of conveyance, because of the direction in which the second section extends. However, production of the form of embodiment which comprises a control cam is relatively expensive, compared with other forms of embodiment of the present invention.

The conveying element is preferably produced from a moisture-absorbing (hygroscopic) plastic material, such as is known from the prior art, or else an inner wall of the casing may be provided with such a material. Alternatively or additionally, the lift element may have a receiving region for a drying agent. The lid may also comprise a drying agent. However, in order to be able to construct a flat lid, for reasons which will be mentioned below, said lid is preferably likewise manufactured, at least partially, from a moisture-absorbing plastic material. At any rate, this applies to the wall regions of the lid, which are located inside the dispensing device.

In another alternative configuration, the retaining means may comprise a plurality of first spring tongues (elastic “folding scales”) which are arranged on an inner face of the casing and are suitable for interacting in such a way with that lower end of the stack of tablets which is the opposite end from the removing aperture, or with a lift element that carries said stack of tablets, that they permit a movement, in relation to the casing, of the stack of tablets or of the lift element towards the removing aperture, and impede a movement counter to the direction of conveyance. In this way, a lift element may be dispensed with entirely or may be configured in a very simple manner, in particular without elastic elements, in order to interact with the casing. In addition, the holding means may comprise a plurality of second spring tongues/folding scales, which are arranged on the conveying element and are suitable for interacting in such a way with that end of the stack of tablets which is the opposite end from the removing aperture, or with the lift element, that they permit a movement of the conveying element, in relation to the stack of tablets or to the lift element, counter to the direction of conveyance, and entrain the tablet which is located lowest or the lift element when a movement of the conveying element in said direction of conveyance occurs.

In one form of embodiment, the conveying element is essentially of tubular, that is to say hollow-cylindrical configuration. In this case, the conveying element receives the stack of tablets in its interior. Under these circumstances, the side wall (shell wall) of the conveying element may be perforated in any desired manner in order to save on material, so long as the stability of the conveying element is guaranteed. Said conveying element preferably has a distal dispensing region which is suitable for delimiting the stack of tablets in the direction of conveyance. For this purpose, the conveying element preferably has a suitable covering wall which closes it off in the distal direction. A removing aperture is preferably constructed laterally in the said distal dispensing region in such a way that a foremost tablet in the stack of tablets, which tablet is received in the dispensing region, can be removed from said dispensing region through the removing aperture, transversely to the direction of conveyance.

What is achieved by means of a lateral removing aperture is that tablets can be reliably removed in the desired quantity because they cannot drop out of the dispensing device in a relatively uncontrolled manner. For reasons which will be mentioned below, the construction of the lateral removing aperture in the conveying element (and not, say, in the casing) brings about suitable limitation of the movement of the conveying element from the dispensing position into the conveying position. What is achieved in this way is that, after a tablet has been removed, the stack of tablets is displaced upwards by the necessary length of travel by actuation of the conveying element, in order to thus prepare a next tablet for removal.

The conveying element is preferably spring-loaded from the conveying position into the removing position, that is to say, in the direction of conveyance. This facilitates one-handed operation. In this case, the conveying element is preferably arranged in such a way that it can be pressed into the casing with the thumb, against the spring force. On being released, the conveying element is pressed back into the dispensing position again because of the spring force.

This can be achieved through the fact that a spring element is arranged between the casing and the conveying element. This spring element may, in particular, be arranged between a proximal end region of the conveying element and a base region of the casing. In one simple configuration, the spring element comprises a first ring, a second ring and a plurality of elastic webs which connect the rings and extend, essentially inside a peripheral face, at an inclination to the direction of conveyance.

The spring element and the lift element can be produced in one piece with one another in a simple manner, and can be connected to one another via preset breaking points. Said preset breaking points are then dimensioned in such a way that they either break as early as when the dispensing device is assembled, or else, at the latest, when the conveying element is actuated for the first time. Joint, one-piece production of the spring element and lift element reduces the manufacturing and assembly costs in an advantageous manner.

A spring force may also be generated by the casing itself instead of by a spring element. For this purpose, the casing may have a bellows-like region which can be expanded, with respect to the direction of conveyance, against a spring force. The bellows-like region subdivides the casing into a distal section which is adjacent to the removing aperture, and a proximal section which is remote from said removing aperture. The conveying element is then inserted in the proximal section in such a way that said proximal section is entrained when a movement of the conveying element, in relation to the distal section, occurs counter to the direction of conveyance, and the bellows-like region is thereby expanded. As a result of this, the said region generates a restoring spring force upon the conveying element.

The tablets are basically stacked one above the other in the dispensing device and are fixed in position in this location. Mechanical damage to the tablets is thus avoided. This is particularly important when it is a matter of precise dosing operations. Because if, for example, a tablet which promotes a person's health is mechanically damaged, a patient would receive too low a dose as a result of taking the mechanically damaged tablet. This form of embodiment therefore also serves, above all, for storing medicaments which are administered in the form of tablets.

If, of course, a tablet is removed and the remaining stack of tablets is not immediately afterwards displaced upwards again towards the removing aperture or lid in an appropriate manner, the advantageous fixing in position is basically no longer guaranteed. This situation occurs, for example, if a conveying element has to be actuated manually in order to displace the remaining stack of tablets upwards towards the removing aperture in a suitable manner. In order to avoid even this undesirable situation, in one form of embodiment of the invention there is an upper stop adjoining the removing aperture and/or adjacent to the lid of the dispensing device.

The stop may, for example, be of annular construction inside the conveying element. The said stop is arranged in such a way that it is located immediately below the tablet which has been made ready for removal. The remaining part of the stack of tablets then impinges, with its “upper” end, against the said stop and is thus held in its location, even when the tablet located above it is removed. The risk of mechanical damage to the tablets is thus minimised, since they are held below the stop. The elasticity and size of the stop is matched to the tablets in such a way that a tablet belonging to the stack of tablets is able to pass the stop as a result of sufficient pressure, in order to thus pass into the position from which the said tablet can be removed.

In order to be able to produce the dispensing device in a simpler and more economical manner, the conveying element comprises, in one form of embodiment of the invention, two half-shells which are joined together to form a tube. The two half-shells are preferably connected to one another by form-locking. It is relatively difficult to produce a tube with internally located blocking scales and the like. This problem is solved by producing two half-shells, which can be produced in a very much simpler, and therefore more economical, manner. In order to promote a secure connection between the half-shells, the removing region with the covering wall and removing aperture of the conveying element is preferably also manufactured separately and inverted over the to joined-together half-shells in such a way that said half-shells are held together, at least in a supplementary manner, by the separately produced removing region.

Any desired combinations between the various configurations described are possible. Thus, for example, the way in which the spring force is generated is independent of whether a lift element is present and the way in which said element is guided.

### BRIEF DESCRIPTION OF THE DRAWINGS

Preferred forms of embodiment of the invention will be described below with the aid of the drawings, in which:

FIG. 1 shows a perspective view of a first exemplified embodiment of a dispenser;

FIG. 2 shows a side view of the dispenser in FIG. 1 in the direction of viewing II-II;

FIG. 3 shows a central longitudinal section through the dispenser in FIG. 1 in the direction of viewing II-II;

FIG. 4 shows a longitudinal section according to FIG. 3, but with the lid open;

FIG. 5 shows a perspective view of the dispenser in FIG. 1, with the lid open;

FIG. 6 shows another perspective view of the dispenser, with the lid open;

FIG. 7 shows a perspective sectional view of the casing of the dispenser in FIG. 1;

FIG. 8 shows a perspective view of the inner tube of the dispenser in FIG. 1;

FIG. 9 shows a side view of the inner tube in the direction of viewing IX-IX in FIG. 5;

FIG. 10 shows an enlarged perspective view of the lift and spring element of the dispenser in FIG. 1;

FIG. 11 shows another enlarged perspective view of the parts in FIG. 10;

FIG. 12 shows a side view of the parts in FIG. 10, in a direction of viewing which is rotated by 90° in relation to the direction of viewing IX-IX;

FIG. 13 shows a central longitudinal section through the parts in FIG. 10, in the direction of viewing IX-IX;

FIG. 14 shows a perspective view of a variant of the parts in FIG. 10;

FIG. 15 shows another perspective view of the variant in FIG. 14;

FIG. 16 shows a central longitudinal section through the variant in FIG. 14, in the direction of viewing IX-IX;

FIG. 17 shows a perspective view of the casing of a second exemplified embodiment;

FIG. 18 shows a perspective view of the casing of a third exemplified embodiment;

FIG. 19 shows a perspective view of the casing of a fourth exemplified embodiment;

FIG. 20 shows an enlarged representation of a detail of an inner tube with folding scales;

FIG. 21 shows a central longitudinal section through a dispenser according to a fifth exemplified embodiment, along a sectional plane which extends through the latching cams on the lift element;

FIG. 22 shows an enlarged detail view of a proximal end region of FIG. 21;

FIG. 23 shows a perspective view of the outer tube of the dispenser in FIG. 21;

FIG. 24 shows a perspective view of the closing-off element of the dispenser in FIG. 21;

FIG. 25 shows a plan view of a lift element;

FIG. 26 shows a first lateral section through a detail of one form of embodiment of the dispensing device; and

FIG. 27 shows a second lateral section through a detail of one form of embodiment of the dispensing device.

### DETAILED DESCRIPTION OF PREFERRED FORMS OF EMBODIMENT

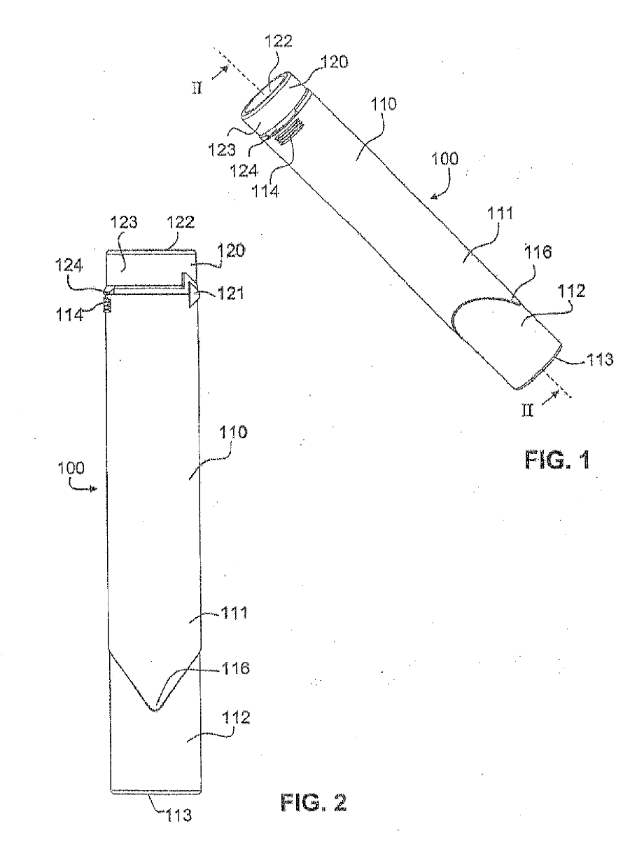

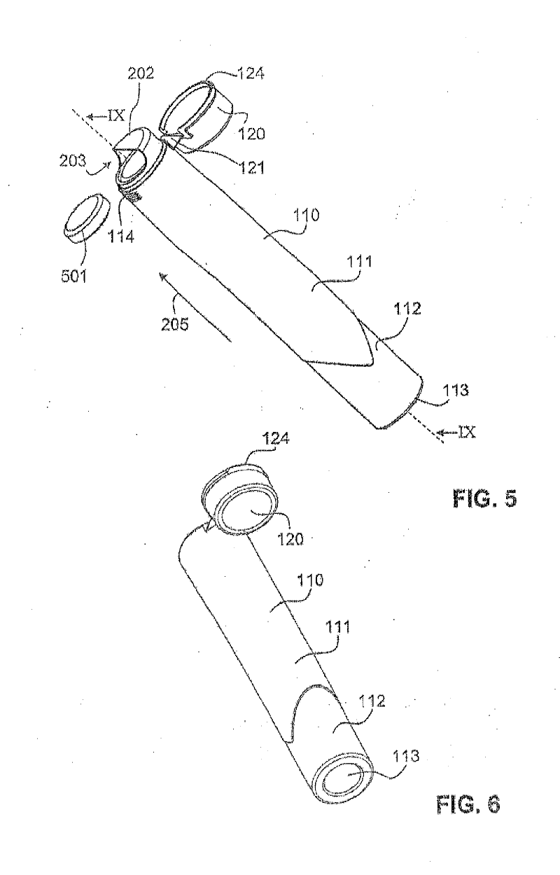

A first exemplified embodiment of a tablet-dispenser according to the invention is represented in FIGS. 1 to 6. The dispenser, that is to say the dispensing device, has a casing 100 in the form of an outer tube 110 having a lid 120 which is connected to said outer tube in one piece via a film hinge 121. Said outer tube 110 has a cylindrical side wail which is subdivided, by a V-shaped orientation aid 116 for assembly purposes, into a first side-wall region 111 and a second side-wall region 112 with a slightly smaller internal diameter. The external diameter is also advantageously correspondingly smaller, as can be seen from FIG. 1, for the purpose of providing an external, visual orientation aid. The inner wall of the outer tube thus comprises a funnel-shaped, downwardly tapering guide for latching cams 302 or the like belonging to a lift element which is to be inserted. By means of the guide, the latching cams are directed into the desired position, a fact which, above all, facilitates assembly of the corresponding individual parts of the dispensing device.

The outer tube 110 is closed off towards the bottom by a base 113 and is connected to the latter in one piece and therefore integrally. Constructed at the upper end of the outer tube, opposite the film hinge 121, is an opening aid 114. The lid 120 of the casing has a short, cylindrical side-wall region 123 and an upper covering wall 122. This side-wall region is preferably only as high as is necessary to be able to seal the removing aperture 203 of the conveying element, which aperture projects in relation to the casing, in a moisture-tight manner. The height of the lid is therefore, at most, only slightly higher than the height of the removing aperture 203. Basically, the height of the side wall 123 is therefore greater than the thickness of a tablet and less high than twice the thickness of a tablet. This does not apply, of course, if the tablets are very much thinner, compared to the height of the removing aperture. The lower the height of the side-wall region 120, the more mechanically stable is said region, and the lower the risk of a leak occurring in an undesirable manner. In this form of embodiment therefore, the accommodation of a drying agent in the lid, which would undesirably increase the height of the latter, is advantageously dispensed with.

An opening aid 124 is also constructed on the lid, opposite the film hinge 121. In addition, there may be constructed on the lid an element, not represented here, which guarantees first-time opening and is irreversibly altered or destroyed when the lid is opened for the first time, and which is thereby suitable for indicating that the dispenser is intact. The lid may also be constructed in a different manner from that represented here and may, in particular, have a child-proofing device such as is known in various forms from the prior art. It may also be constructed as a screw-on lid, etc., although a screw-on lid has the disadvantage that two hands are normally required in order to open the dispensing device and close it again. A snap-on lid, which is permanently connected to the dispensing device by means of a film hinge and, as a result, cannot get lost, is therefore to be preferred.

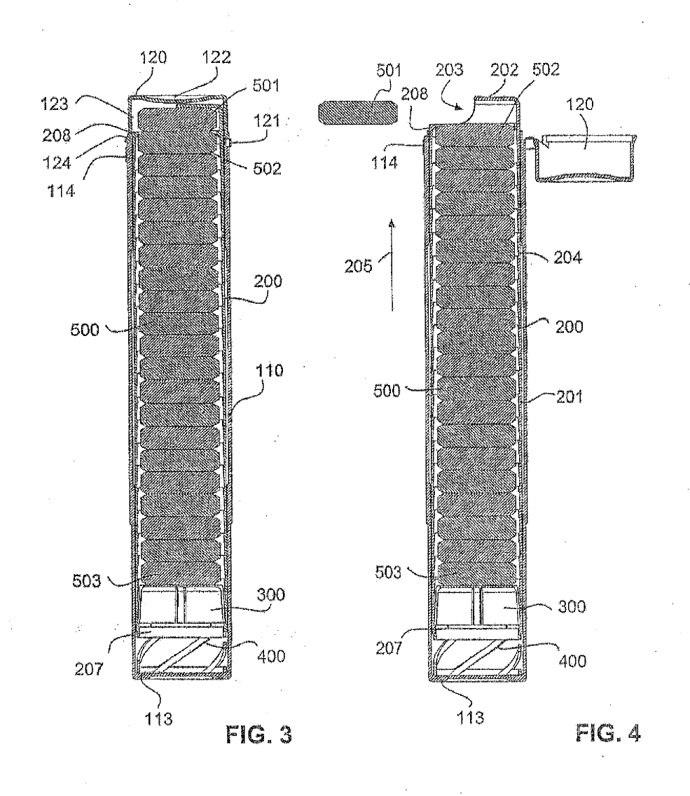

Arranged in the outer tube 110 is a conveying element in the form of an inner tube 200, which can be seen particularly clearly in FIGS. 3 and 4. Said inner tube 200 is open in the downward direction. It has an essentially cylindrical side wall 201 on the outside. The inner tube is closed off, at its upper end, by means of a removing region 202 which partially masks the tube in the upward direction and unblocks a lateral aperture 203 for the removal of one tablet 501 at a time from a stack of tablets 500 which is received in the inner tube. This ensures that, irrespective of the lid, there is an upper stop for the foremost tablet 501 that can be removed. The risk of mechanical damage is thus reduced in a further improved manner. Through the fact that the tube is only partially masked in the upward direction, the uppermost tablet can be easily reached from above and easily pushed out sideways. This is particularly advantageous if the upper tablet is held with a gripping action. Failing this, the inner tube may also be completely masked in the upward direction, without there being any need to fear major disadvantages from the handling point of view.

The inner tube 200 rests, with its open lower end 207, on a spring element 400. It is longitudinally displaceable, within the outer tube 110, along the common cylinder axis of the inner and outer tubes in a direction of conveyance 205 and counter to the said direction of conveyance. The starting position, which will also be referred to below as the dispensing position, is the position which is represented in FIGS. 3 and 4. In this position, the inner tube 200 protrudes sufficiently far above the upper rim of the outer tube 110 for the removing aperture 203 to be freely accessible from the side. In the dispensing position with the lid 120 open, the uppermost tablet 501 in this stack can be pushed out sideways through the removing aperture 203, or may, under certain circumstances, drop out of the removing region automatically when the dispenser is turned into the horizontal position with the removing aperture 203 downwards.

In particular, a tablet which is uppermost may drop out automatically if the annular stop 208—which is also called a “retaining bead”—is positioned in such a way that said uppermost tablet 501 is supported in an easily displaceable manner. This can be achieved, in particular, through the fact that a minimal clearance (in the upward or downward direction) is left for the uppermost tablet 201 so that, on the one hand, the uppermost tablet 501 can easily drop out sideways and, on the other hand, possible movements along the longitudinal, axis II-II Are restricted in such a way that there is no need to fear mechanical damage. The possibility of being able to use the dispensing device with only one hand is promoted in an improved manner in this form of embodiment.

The inner tube can be pushed into the outer tube counter to the direction of conveyance 205, under which circumstances the spring element 400 is compressed and a restoring force, which acts in the direction of conveyance, is exerted upon the inner tube. Said inner tube can be pushed in, against the said restoring force, as far as a second position, the so-called “conveying position”. When the inner tube is released again, it returns to the dispensing position automatically because of the restoring force.

In the representation in FIGS. 1 to 6, the hinge 121 of the lid 120 is arranged on the side diametrically opposite the removing aperture 203. Instead of this, it is also possible to provide for a different angle between them, in particular for an arrangement of the hinge and removing aperture which is offset by 90° about the direction of conveyance.

A lift element 300 is guided within the inner tube 200. The bottommost tablet 503 in the stack of tablets 500 rests on said lift element 300.

The way in which the dispenser functions is as follows: If another tablet in the stack 500 is to be removed after the uppermost tablet 501 has been dispensed, the user presses the inner tube 200 into the conveying position against the spring force of the spring element 400. In the process, the lift element 300 is held on the outer tube 110 in such a way that the stack of tablets 500 remains unchanged in its location in relation to said outer tube 110. The inner tube 200 is therefore lastly displaced downwards, in relation to the stack of tablets 500, by the thickness of one tablet, until the covering wall of the removing region 202 rests on the tablet which is now located uppermost and prevents a further movement of the inner tube counter to the direction of conveyance. If the inner tube is now released again, the spring element 400 presses said inner tube back into the dispensing position again. In the process, the lift element is now entrained in the direction of conveyance 205 by the inner tube 200. As a result, the entire stack of tablets 500 is displaced upwards by the height of one table in relation to the outer tube. The uppermost tablet in the stack of tablets 500 is now located in the removing region 202 once again, ready for removal.

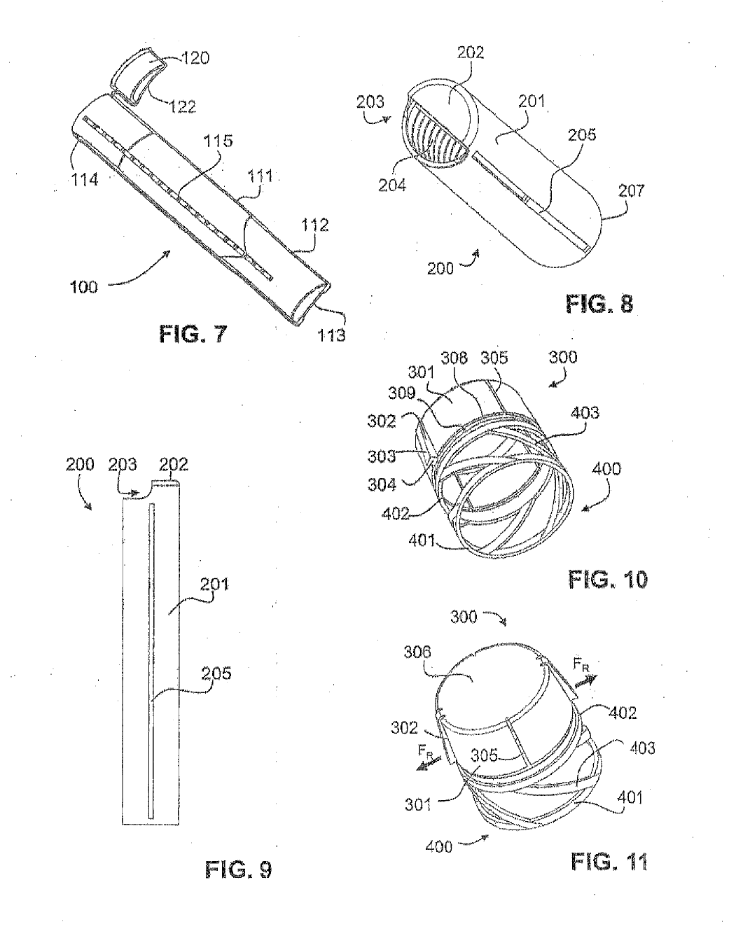

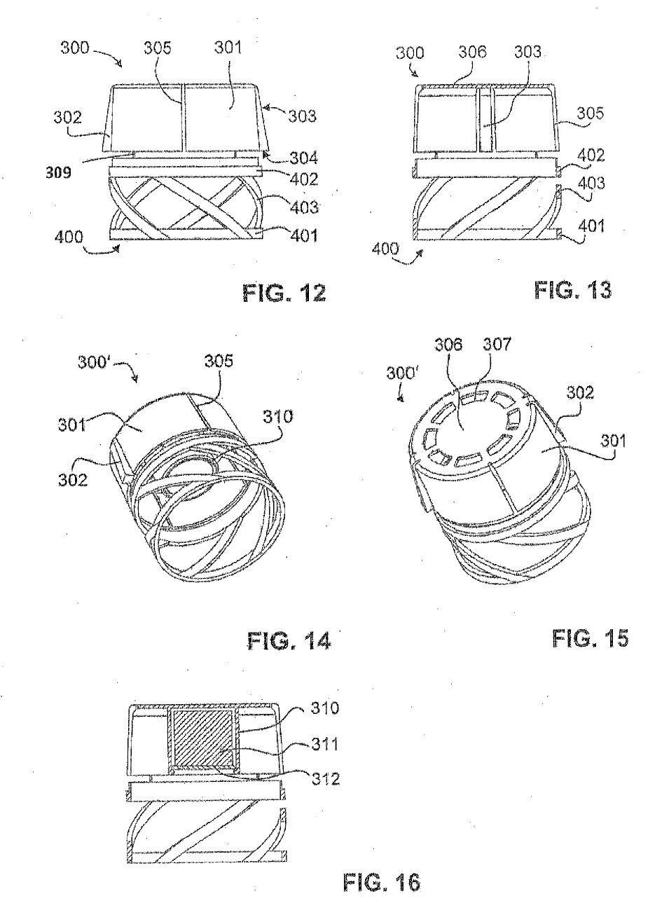

The interaction of the inner tube, outer tube, lift element and spring element will be explained in greater detail in FIGS. 7 to 13, which show these elements separately in each case.

The lift element 300 has a frustoconical side wall 301 which is closed off in the upward direction by means of a covering face 306. Located in the side wall are two opposed longitudinal slits 305 which make it possible to press the lift element together along a transverse direction which extends perpendicularly to the line connecting said slits 305. This gives rise to a deforming force F_{R}, as is indicated in FIG. 11. Two latching cams 302 are constructed on the side wall 301 of the lift element 300 in a manner offset by 90° in relation to the slits 305. Said latching cams have a sliding face 303 which extends in a manner inclined at a shallow angle to the longitudinal axis and the distance of which from the central axis increases continuously in the downward direction. At the lower end, the latching cams 302 each have a stop face 304, the surface normal of which points essentially counter to the direction of conveyance.

In the present example, the lift element 300 and the spring element 400 are produced jointly from an elastic plastic, for example polyethylene (PE). The lift element 300 is connected to the spring element 400 via narrow bridges 309, which form preset breaking points. These preset breaking points break on assembly or, at the latest, the first time the tablet-dispenser is actuated, and the lift element 300 becomes completely independent of the spring element.

The spring element consists of a lower ring 401, an upper ring 402 which is arranged so as to be offset in relation thereto along the direction of conveyance, and a plurality of spring webs 403 (five spring webs in the present example) which connect the two rings and extend at an inclination to the longitudinal axis. If the two rings 401, 402 of the spring element are pressed towards one another, elastic shearing forces, which press the two rings apart from one another again and in this way generate a spring force, are produced in the spring webs 403. The spring element may, however, also be constructed in a different way and may in particular be produced, preferably from plastic, in a manner which is known per se.

On the inside of its side wall 201, the inner tube 200 has a large number of blocking scales 204. Each of these blocking scales has a sliding face which is inclined in relation to the longitudinal axis, so that the internal diameter of the side wall 201 initially tapers in the upward direction (in the direction of conveyance) in the region of the said sliding face in each case, only to then abruptly widen out again in the region of an upwardly pointing stop face. The lift element is able to slide upwards (in the direction of conveyance) in the interior of the inner tube 200. In the process, it is slightly deformed elastically by the sliding faces of the blocking scales 204 in each case. As soon as the lower edge 308 of the lift element 300 has left the region of a sliding face and has passed beyond the stop face, the lift element widens out again slightly. If an attempt is now made to push the lift element back within the inner tube, counter to the direction of conveyance, the lower edge 308 of said lift element strikes against the stop face of the blocking scale in question, as a result of which pushing-back is prevented. Because of this, the lift element is only able to move upwards within the inner tube (in the direction of conveyance) stepwise by the distance between adjacent blocking scales in each case.

On opposite sides of the side wall 201, the inner tube 200 has two longitudinal slits 205 through which latching cams 302 on the lift element pass. These latching cams interact with blocking scales 115 which are constructed on the inner face of the side wall of the outer tube 110. The said blocking scales form a narrow strip which extends along the longitudinal direction and is let into a groove in the side wall in a slightly recessed manner. The lift element 300 is guided along within the said groove by means of the latching cams 302 and, in this way, is secured against twisting in relation to the outer tube.

Through the fact that the latching cams 302 are guided by the slits 205 in the inner tube, said inner tube 200 is also secured against twisting in relation to the outer tube 110. This guarantees that the removal aperture in the conveying element always remains accessible.

The orientation aid 116 contributes to the latching cams 302 passing into the blocking scales 115 which are arranged in a recessed manner.

Alternatively, undesirable twisting may also be guarded against by means of a separate groove-and-tongue connection between the outer and inner tubes, which extends parallel to the longitudinal axis of the dispensing device. In this case in particular, the blocking scales may be, for example, of annular configuration.

The latching cams 302 have a sliding face 303 which extends at an inclination to the longitudinal axis, so that the distance of the sliding face from the central axis increases in the downward direction. Constructed at the lower end of the latching cams are stop faces 304 which are directed essentially downwards (counter to the direction of conveyance). When the lift element is pushed upwards, relative to the outer tube, the latching cams 302 slide, by means of the sliding faces 303, over the blocking scales 115. As a result, the lift element is pressed together, counter to the deforming force F_{R}, in the transverse direction. As soon as the latching cam 302 has passed, with its stop face, over a blocking scale 115, it is pressed by the deforming force into the region between two consecutive blocking scales. If an attempt is now made to push the lift element back, counter to the direction of conveyance, the stop face 304 encounters a stop face of the blocking scales 115 which is oriented in the opposite direction, so that pushing-back is prevented.

The lift element 300 can therefore only be displaced in the direction of conveyance stepwise, in relation to both the outer tube 110 and the inner tube 200, by the distance between two consecutive blocking scales 115 or 204 in each case, and is accordingly inhibited, in stages, from displacement in the opposite direction. This ensures that the lift element 300 remains stationary in relation to the outer tube when the inner tube 200 is pressed into said outer tube 110, so that said inner tube 200 is displaced, in relation to the stack of tablets, counter to the direction of conveyance by the thickness of one tablet. What is further ensured is that, when the backward movement of the inner tube occurs, the lift element is entrained by said inner tube in the direction of conveyance by the thickness of one tablet. In the process, the thickness of one tablet corresponds precisely to the distance between two consecutive blocking scales 115 or 204. In this way, the stack of tablets is conveyed in the direction of conveyance by the thickness of one tablet every time a forward-and-backward movement of the inner tube occurs.

However, the blocking scales may also have a distance between them which corresponds only to an integral fraction of the thickness of one tablet. In this case, the latching cam of the lift element slides over a number of blocking scales in each case when a tablet is conveyed. This makes it possible to use the same dispenser for tablets of different thickness. In addition, it is conceivably possible to provide, on the lift element, a number of latching cams which are arranged one behind the other in the direction of conveyance, in order to distribute the retaining forces better.

In one variant of this first form of embodiment, the lift element may additionally be constructed as a holder for a drying agent, as is represented in FIGS. 14 to 16. For this purpose, the lift element has an annular receiving region 310 in which a cylindrical tablet or granulate of a drying agent 311 is received. The drying agent is held in the receiving region 310 by a small holding plate 312 which may consist, for example, of gas-permeable cardboard. In order to permit an exchange of gas between the drying agent 311 and the region of the stack of tablets, the covering wall 306 of the lift element has a plurality of through-apertures 307 in this configuration.

Alternatively or additionally, the inner tube 201 may be formed from a plastic composite material which itself has moisture-absorbing (hygroscopic) properties, for example a molecular sieve-type material. A plastic material of this type is disclosed, for example, in WO 97/032663. Manufacturing the inner tube from a moisture-absorbing material advantageously causes the interior space to be kept dry in a homogeneous manner. The tablets are accordingly protected homogeneously against moisture. Since, moreover, the tablets are held in their position in a stacked manner, this additionally ensures that tablets are not protected against moisture with differing degrees of success.

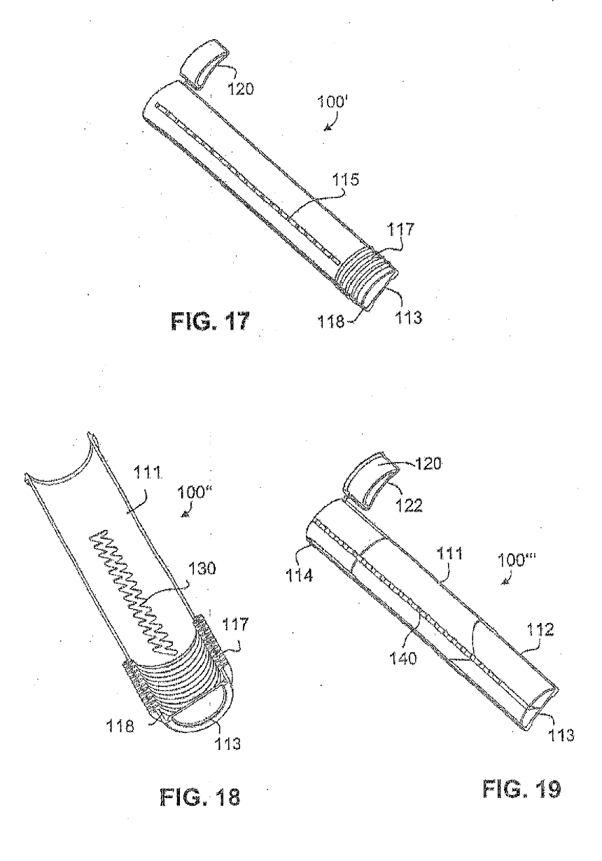

A second form of embodiment of the present invention is illustrated in FIG. 17, which shows the casing 100′ of a correspondingly configured tablet-dispenser. Parts which are the same are provided, below, with the same reference numerals as in the first form of embodiment. Omitted in this form of embodiment, the spring element 400 previously described is replaced by a bellows-like region 117 in the region of the side wall of the casing, which bellows-like region subdivides the casing into a distal section and a proximal section 118 which is adjacent to the base 113. The inner tube 200 is configured in a manner similar to that in the first form of embodiment. In this form of embodiment too, there is again present a lift element which interacts with the blocking scales 115 on the casing and blocking scales on the inner tube in the same way as in the first form of embodiment, so that said lift element can be displaced, both in the inner tube and in the outer tube, in the direction of conveyance by the thickness of one tablet in each case, whereas it is inhibited from displacement counter to the direction of conveyance. In the dispensing position, the inner tube rests, in this form of embodiment, by means of its lower end on the base 113 of the outer tube. If the inner tube is now pressed in, counter to the direction of conveyance, from the dispensing position into the conveying position, it draws the bellows-like region 117 apart against an elastic restoring force. In this form of embodiment too, the said elastic restoring force causes the inner tube 200 to return to the dispensing position again after being released. However, this form of embodiment requires comparatively expensive production and is therefore less to be preferred.

A third form of embodiment is illustrated in FIG. 18, which once again shows the casing 100″ of a dispenser. Here, the lift element is guided on the casing via two diametrically opposed control cams 130, instead of via a ratchet connection. For this purpose, the lift element has two corresponding control pins which engage in the control cam. Said control cam is configured in the form of a zigzag, with sections that extend at an inclination of about 45° to the longitudinal axis, and sections that extend transversely to said longitudinal axis. In this instance, the inner tube is once again configured in a manner similar to that in the first two forms of embodiment. When the inner tube is pressed in, the lift element remains fixed in position in the transversely extending sections of the control cam by means of its control pins. When the backward movement of the inner tube occurs, said lift element is entrained by the latter along an inclined section and passes, by means of the control pins, into the next transversely extending section. In order to ensure this, the inner tube may be fixed in position in the proximal region of the casing in such a way that, when the backward movement occurs, a torque which presses said lift element into the transversely extending sections is produced upon the inner tube, and thus upon the lift element. Naturally, the form of embodiment with a control cam can also be realised with a spring element 400 instead of a bellows-like design on the casing.

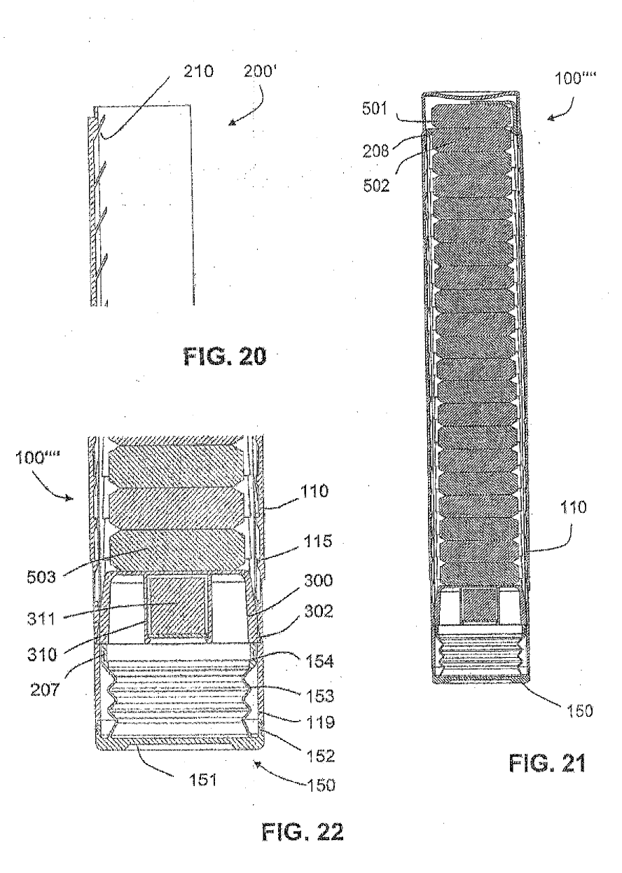

In a fourth form of embodiment, such as is illustrated in FIGS. 19 and 20, a lift element may be omitted completely. In this form of embodiment, there are arranged on the inner face of the side wall of the casing a large number of spring tongues (folding scales) 140 which, in the non-tensioned position, project obliquely upwards (distally) from the inner wall and internally at an inclination in relation to the longitudinal axis. This is represented in FIG. 19. Corresponding spring tongues 210 are also arranged on the inside of the side wall of the inner tube 200′ and are oriented in the same way, as can be seen in the enlarged representation of said inner tube 200′ in FIG. 20. The tablets in the stack of tablets 500 are able to slide over these spring tongues 140 or 210 in the direction of conveyance. In the process, they press the spring tongues 140 or 210 outwards against an elastic force. As soon as the bottommost tablet in the stack of tablets has slid over a spring tongue, the latter folds into the non-tensioned position because of its spring force, and now rests with its upper end against the underside of the bottommost tablet. In this way, it prevents the bottommost tablet from being pushed back again.

The rest of the way in which this form of embodiment functions corresponds to the way in which the first form of embodiment functions. The inner tube is, once again, pressed from the dispensing position into the conveying position against the spring force of a spring element in the outer tube. When this pressing-in movement occurs, the stack of tablets remains stationary, in relation to the outer tube, on account of its engagement with the folding scales 130 on the latter. When the inner tube is released, it is pressed back into the dispensing position again by the spring element and, in the process, entrains the stack of tablets because of the engagement of the folding scales/spring tongues on the inner tube with said stack, and thereby conveys said stack of tablets upwards as a whole by the thickness of a single tablet.

In this form of embodiment too, it is naturally possible to use a lift element which is constructed, in the simplest case, as a shallow, round disc having the diameter of a single tablet, and on which the bottommost tablet rests. In this case, the said lift element interacts, instead of the bottommost tablet, with the folding scales/spring tongues. In this form of embodiment too, it is naturally possible to construct on the casing a bellows-like region, such as in the second or third form of embodiment, which acts as a spring element. In this variant too, the inner tube may be formed from a moisture-absorbing plastic material.

In the forms of embodiment which have been represented above, the outer tube or the casing has a fixed base 113. Filling therefore necessarily takes place from above through the region of the lid. In particular, it is necessary for the inner tube and, if applicable, the lift and the spring element to be introduced into the outer tube from above. Under these circumstances, either aids are necessary in order to be able to push the lift or the stack of tablets into the outer tube (for example in order to press in the latching elements or folding scales), or else these parts may be configured in such a way that the lift or the stack of tablets can be pushed, at least in the heated state, into the outer tube from above with suitable application of force.

However, the filling operation turns out to be simpler if the outer tube is initially open in the downward direction, and is sealed at the lower end only after said filling operation. In this case, the outer tube, the lid and an indicator of first-time opening (for example a guarantee strip) may be, in particular, injection-moulded in one piece with each other.

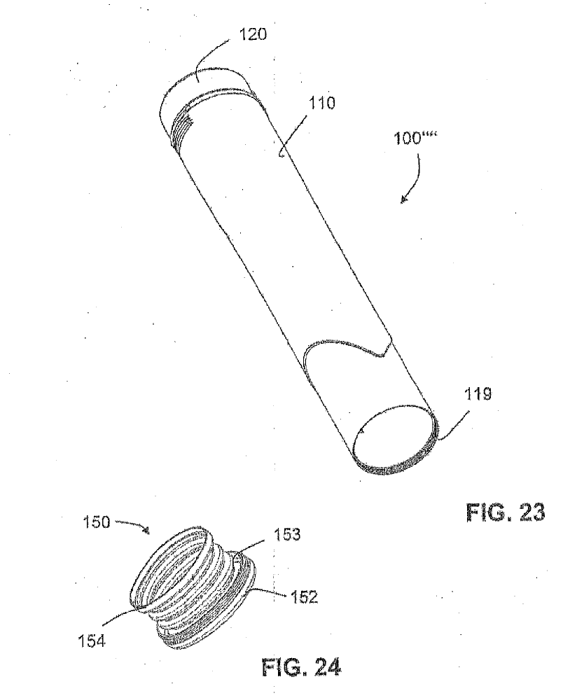

A form of embodiment of this type is illustrated, on an exemplary basis, in FIGS. 21 to 24. In this form of embodiment, the outer tube 110 of the casing 100″″ is open at its proximal end 119 and has, in this region on its inner face, for example one or two circumferential annular grooves which serve as latching grooves for a proximal closing-off element (base cap) 150. Said base cap 150, which is represented on its own in FIG. 24, has a base 151 and an outer, circumferential, short side wall 152. Constructed on the outside of the side wall are, for example, one or two circumferential webs which interact with the latching grooves in the outer tube in such a way that the closing-off element 150 is securely held in the outer tube 110 in a form-locking manner after it has been pushed into said outer tube for the first time. Protruding upwards from that region of the base 151 which is delimited by the side wall 152 is a bellows-like region 153 which terminates, at its upper (distal) end, at a receiving ring 154 into which the lower end 207, which is of complementary configuration, of the inner tube protrudes. As a result, the bellows-like region 153 in this form of embodiment replaces the spring element of the first form of embodiment. Instead of this, however, it is naturally also possible, in this form of embodiment with an open proximal end, to provide a separate spring element, or else the casing itself may be provided with a bellows-like region, such as is the case in the form of embodiment in FIG. 18.

In order to facilitate assembly, the proximal closing-off element may, in addition, also be produced in one piece with the lift element. Alternatively, the inner tube may also be produced in one piece with the spring element, and separately from the casing. If the closing-off element is connected to the lift element in one piece, which is advantageous from the production engineering point of view, there is a preset breaking point between the proximal closing-off element and the lift element. Provision may also be made for the one-piece production of a proximal closing-off element, a spring element and a lift element which is connected to said spring element via a preset breaking point, in order to thus achieve advantages in production and/or assembly.

In this form of embodiment, the filling operation takes place from the proximal side. After the filling operation has been completed, the closing-off element 150 is pressed into the outer tube and thereafter remains fixed in position in said outer tube because of the connection between the annular grooves and the webs.

It is advantageous, but not absolutely necessary, to connect the lower end of the outer tube 100″″ to the base by form-locking. Irrespective of whether the base 150 is connected to the outer tube 100″″ by form-locking or, for example, solely or additionally by force-locking and/or by adhesion, fusion, etc., it is, in any case, advantageous to ensure moisture-tight sealing. A minimum prerequisite for this is that no clearance remains in the connection between the base 150 and the outer tube 100″″. There is advantageously at least a press fit, or else the base is integrally connected to the lower end of the outer tube, for example by fusion, in order to thus obtain a moisture-tight connection in a particularly reliable manner.

Although the person skilled in the art knew how tablets can be protected against moisture in a dispensing device, he nevertheless did not know of any way in which this is possible in the case of a dispensing device in which tablets can be transported individually towards the removing aperture, for example by means of a lift element.

The individual elements of the dispenser are preferably produced from the following materials by the injection-moulding method, although other materials are also possible:
casing: polypropylene (PP) or polyethylene (PE)
inner tube: PP, PE or moisture-absorbing composite
lift/spring element: PP or PE

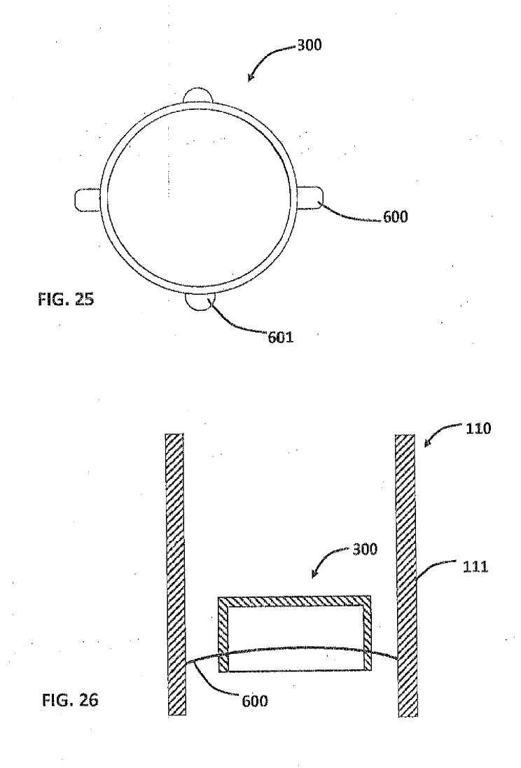

FIGS. 25 to 27 show another, particularly preferred form of embodiment of the lift element 300. Instead of latching cams consisting of plastic, the two ends of a flat elastic element 600, which preferably consists of spring steel, protrude on either side, as is made clear by the plan view of a lift element in FIG. 25. The two ends are bent downwards towards the outside, as FIG. 26 illustrates. A lateral section through the lift element shown in FIG. 25 is represented in FIG. 26. As distinct from the forms of embodiment previously described, the two ends of the element 600, which preferably consists of spring steel, rest in a pretensioned manner against preferably smooth inner wall regions of the outer tube. If, for the reasons mentioned above, there is a first wall region 111 and a second wall region 112, the ends of the flat element 600, which preferably consists of spring steel, rest against the inner wall regions 111, as is shown in FIG. 26 in the form of a detail. As, has been described above, the lift element is located in the interior of an inner tube 200, although the latter is not visible in FIG. 26. The ends of the flat element 600, which preferably consists of spring steel, reach through two longitudinal slits in the inner tube. Since the ends of the element 600, which consists of, preferably, spring steel, are bent downwards, as represented, the lift element can be successfully moved upwards towards the removing aperture without any problems in the manner described, in spite of the pretensioning. However, the lift element 300 is not displaced downwards, since the ends cling to the adjoining inner wall region.

Although steel is more expensive than plastic, it is nevertheless now possible to dispense with producing blocking scales 115 or the like, as a result of which the production of the outer tube can be made cheaper. An essential advantage of this form of embodiment is then the fact that the lift element can be moved upwards continuously, relative to the outer tube, and held in any desired position, so that a movement in the opposite direction is prevented. This provides one prerequisite for being able to accommodate tablets of any desired different thickness in, and remove them from, the dispensing device, so long as they fit through the removing aperture.

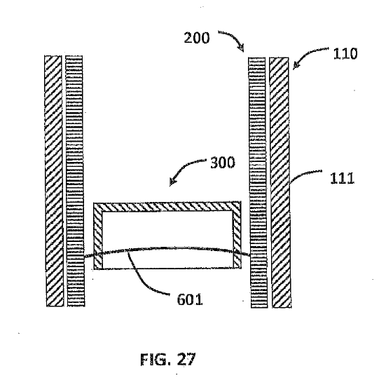

In addition, there is another flat elastic element 601 which preferably consists of spring steel and both ends of which likewise protrude laterally from the lift element and are bent downwards. These two ends rest against inner wall regions of the inner tube 200 in a pretensioned manner, as can be seen from FIG. 27. FIG. 27 corresponds to the representation from FIG. 26. In this case, however, a detail which is rotated by 90° (rotation about a longitudinal axis) is portrayed. These inner wall regions are likewise preferably smooth, that is to say, are not provided with blocking scales and the like in the manner previously described. If the inner tube, which serves as the conveying element, is now pressed from the dispensing position into the conveying position, the lift element 300 moves, relative to the inner tube, towards the removing aperture. The lift element is compelled to perform this relative movement because, for the reasons mentioned above, it is not moved downwards, relative to the outer tube. If the inner tube is subsequently moved into the dispensing position, the lift element will not move, relative to the inner tube, for the reasons mentioned. However, said lift element is moved, relative to the outer tube, upwards towards the lid. This movement of the lift element, in addition to arresting, is possible in a continuous manner. As distinct from the forms of embodiment mentioned above, therefore, it is no longer necessary to match the dispensing device to the thickness of tablets that are being used.

Compared to the flat elements 600, the flat elements 601 preferably protrude less far laterally since they only have to reach as far as inner wall regions of the inner tube, and not as far as inner wall regions of the outer tube. The flat element 600 preferably forms right angles with the flat element 601, in order to thus minimise the risk of malfunctions during use. Instead of only two flat elements 600 and 601, it is also possible to provide a larger number of flat elements, which are then preferably arranged in the shape of a star. However, this solution is basically correspondingly more expensive to produce. Instead of a flat element 600 or 601, whose ends protrude laterally, it is possible to attach to the lift element spring tongues which point downwards in corresponding manner and which preferably likewise consist of spring steel.

Although it is more economical to provide no blocking scales or the like on inner walls, this nevertheless does not mean that every form of blocking scales must necessarily be omitted in the form of embodiment shown in FIGS. 25 to 27. Thus it is possible to provide, for example, blocking scales of very small dimensions which are at a distance from one another which is substantially smaller, compared to the thickness of tablets which are being planned for. By choosing a small distance between two blocking scales, that is to say, for example, smaller than ⅓ of the thickness of a tablet which is located in the dispensing device, an approximation to the situation involving continuous movement and arresting of the lift element is achieved. The smaller the distance between blocking scales, the more successful is this approximation, the consequence of which is that the production of the dispensing device does not have to be matched to the thickness of tablets which are being planned for. It is then also possible to dispense with a material which has comparable properties, such as spring steel.

The two elements 600 and 601 do not necessarily have to consist of steel, if the inner walls are not provided with blocking scales and the like. It is also possible to choose a material by means of which the same actions as have been described can be obtained. What matters, above all, in this connection is that the material behaves in a sufficiently elastic manner, so that a movement of the lift element towards the lid or the removing aperture is possible in spite of the pretensioning. On the other hand, the material is to be selected in such a way that the lift element is capable of moving, relative to the outer or inner tube, towards the removing aperture, and the movement in the opposite direction is preferably prevented or at least adequately impeded.

The shapes of the elements 600 and 601 may also vary, so long as the desired, aforesaid actions which have been described are obtained.

A large number of further modifications are possible, and the invention is in no way restricted to the exemplified embodiments which have been represented here. Thus, for example, the conveying element does not need to be tubular, as in the examples described above, but may also have a different shape which guarantees a satisfactory transmission of force from the upper end to the lower end.

While it is preferred that the conveying element should at least partially surround the stack of tablets, this is not absolutely necessary for functioning purposes, and arrangements are also conceivably possible in which the conveying element is arranged, merely in the form of a bar or partial cylinder for example, on a single side of the stack of tablets, or merely extends along two opposite sides of said stack. The shape of the casing can be adapted, without difficulty, to various requirements, and the casing does not, in any way, need to have the shape of a tube. In particular, a shape other than the circular-cylindrical basic shape represented above is conceivably possible, for example a shape having a square internal cross-section. A large number of other variants are possible.

### LIST OF REFERENCE SYMBOLS

100, 100′, 100″, 100′″, 100″″ casing (outer envelope)

110 outer tube

111 first side-wall region

112 second side-wall region

113 base

114 opening aid

115 blocking scales

116 orientation aid

117 bellows

118 proximal section

119 proximal (lower) end region

120 snap-on lid

121 film hinge

122 covering wall

123 side wall

124 opening aid

125 stop for stack of tablets

130 guide cam

140 folding scales (spring tongues)

150 proximal closing-off element (base cap)

151 base

152 side wall

153 bellows-like region

154 receiving ring

200, 200′ conveying element (conveying tube, inner tube)

201 side wall

202 removing region with covering wall

203 removing aperture

204 blocking scales

205 direction of conveyance

206 slit

207 lower end (proximal end region)

208 retaining bead

210 spring tongues

300 lift element

301 side wall

302 latching cams

303 sliding face

304 stop face

305 slit

306 covering face

307 aperture

308 lower rim

309 preset breaking point

310 receiving region

311 drying agent

312 small holding plate

400 spring element

401 lower ring

402 upper ring

403 spring webs

500 stack of tablets

501 foremost tablet

502 second foremost tablet

503 rearmost tablet

600 flat element consisting of spring steel

601 flat element consisting of spring steel

1.-38. (canceled)

39. A dispensing device comprising (a) an interior space, which is sealed in a moisture-tight manner, for receiving tablets, (b) a transporting means for transporting tablets to a removing aperture in the dispensing device, wherein the dispensing device includes a lift element which can be moved continuously towards the removing aperture, and (c) means for continuously impeding the lift element in the opposite direction.

40. The dispensing device of claim 39, wherein the dispensing device can contain a stack of tablets and can individually dispense tablets from said stack, wherein the dispensing device comprises:
(a) a casing which receives the stack of tablets;
(b) a removing aperture for removing one tablet or a predetermined number of tablets, at a time; and
(c) a conveying element which can be moved, in relation to the casing, in order to convey the stack of tablets to the removing aperture along a direction of conveyance, wherein
the conveying element can be moved to and fro in relation to the casing, between a dispensing position and a conveying position, and, wherein
holding means are present for holding the stack of tablets, relative to the casing, in such a way, that when a movement of the conveying element from the dispensing position into the conveying position occurs, the conveying element is displaced in relation to the stack of tablets and counter to the direction of conveyance; and
which holding means are present for holding the stack of tablets, in relation to the conveying element, in such a way, that when a backward movement of the conveying element from the conveying position into the dispensing position occurs, the stack of tablets is entrained in the direction of conveyance by the conveying element, so that the stack of tablets is conveyed in the direction of conveyance by a predetermined amount every time a forward-and-backward movement of the conveying element occurs.

41. The dispensing device of claim 40, wherein the holding means comprise a lift element on which the stack of tablets rests at a proximal end thereof, which is the opposite end from the removal aperture, and which lift element interacts with the casing in such a way that it can be moved, in relation to the casing, along the direction of conveyance, whereas it is hindered from moving, in relation to the casing, counter to the direction of conveyance, and which lift element interacts with the conveying element such that it permits a movement of the conveying element, in relation to the casing, counter to the direction of conveyance, and is entrained by the conveying element when a movement of said conveying element occurs in the direction of conveyance.

42. The dispensing device of claim 41, wherein the lift element interacts with the casing via a first ratchet connection which permits a movement of the lift element in relation to the casing, in the direction of conveyance and prevents a movement counter to said direction of conveyance.

43. The dispensing device of claim 42, wherein there are constructed, on an inner face of the casing, a plurality of blocking scales which interact with at least one first latching region of the lift element such that they permit a movement of the lift element in relation to the casing, in the direction of conveyance and impede a movement counter to the direction of conveyance.

44. The dispensing device of claim 43, wherein the lift element is elastically deformable, transversely to the direction of conveyance against a deforming force, and wherein the at least one first latching region of the lift element is pressed elastically against the blocking scales by said deforming force.

45. The dispensing device of claim 43, wherein the at least one first latching region is constructed as an elastic spring tongue.

46. The dispensing device of claim 44, wherein the conveying element includes a slit which extends essentially along the direction of conveyance, and wherein the first latching region of the lift element extends through the slit in order to interact with the blocking scales.

47. The dispensing device of claim 40, wherein the lift element interacts with the conveying element via a second ratchet connection which permits a movement of the conveying element, in relation to the lift element, counter to the direction of conveyance and which causes said lift element to be entrained by the conveying element, when a movement of said conveying element occurs, in relation to the casing in the direction of conveyance.

48. The dispensing device of claim 39, wherein the conveying element is produced from a hygroscopic plastic material.

49. The dispensing device of claim 39, wherein a lift element is provided either (1) with two elements which consist of spring steel, or (2) with four spring tongues, the ends of which are bent outwards and downwards away from the removing aperture in the dispensing device, and which rest, with pretensioning, against inner wall regions of the dispensing device.

50. The dispensing device of claim 49, wherein the inner wall regions are smooth.

51. The dispensing device of claim 39, including means which prevent twisting of the casing relative to the conveying element.

52. The dispensing device of claim 39, including a base of the casing of the dispensing device which is connected to an outer envelope by at least one of form-locking, force-locking, and adhesive.

53. The dispensing device of claim 39, including means for fixing the tablets belonging to the stack of tablets in position, which means are located below a preferably lateral removing aperture.

54. The dispensing device of claim 39, including an upper stop for a part of the stack of tablets not including a tablet which has been prepared for removal.

55. The dispensing device of claim 54, wherein the stop is arranged such that one or more tablets which are located above the stop are held, with clearance, inside the dispensing device.

56. The dispensing device of claim 39, including a lid for sealing a removing aperture in a moisture-tight manner, wherein the lid is devoid of drying agent.

57. A method of removing a tablet which is located in the dispensing device of claim 39, the method comprising transporting the tablet within said dispensing device towards the lid with the aid of the lift element, and removal of the tablet.

58. The method of claim 57, wherein a conveying element belonging to the dispensing device is moved forwards and backwards and the lift element is thereby transported towards the lid.
